(19) United States
(12) Patent Application Publication
(10) Pub. No.: US 2025/0321445 A1
(43) Pub. Date: Oct. 16, 2025

(54) DISPLAY DEVICE

(71) Applicant: E Ink Holdings Inc., HSINCHU (TW)

(72) Inventors: Liang-Yu LIN, HSINCHU (TW); Po-Yuan LO, HSINCHU (TW); Ian FRENCH, HSINCHU (TW)

(21) Appl. No.: 19/070,544

(22) Filed: Mar. 5, 2025

(30) Foreign Application Priority Data
Apr. 11, 2024 (TW) 113113627

(51) Int. Cl. G02F 1/1335

(52) U.S. Cl. CPC G02F 1/133514; G02F 1/133524; G02F 1/133616

(57) ABSTRACT

A display device includes a first substrate, a display medium layer, a first color filter layer, a second substrate, a front light module and a second color filter layer. The display medium layer is disposed on the first substrate. The first color filter layer is disposed on the display medium layer and includes multiple first filter patterns. The second substrate is disposed on the first color filter layer. The front light module is disposed on the second substrate. The second color filter layer is disposed between the second substrate and the front light module and includes multiple of second filter patterns.

### CROSS-REFERENCE TO RELATED APPLICATION

This application claims priority to Taiwan Application Serial Number 113113627, filed Apr. 11, 2024, which is herein incorporated by reference in its entirety.

### BACKGROUND

### Field of Invention

The present disclosure relates to a display device. More particularly, the present disclosure relates to a display device including a color filter layer disposed adjacent to a front light module.

### Description of Related Art

The color display device generates a full-color effect by the light passing through the color resist pattern on the color filter layer. In order to improve the display quality of color display devices and expand their application range, a front light module is disposed on the display panel. However, other laminated structures between the front light module and the color filter layer will cause internal refraction or scattering when the light from the front light module enters the display panel, resulting in light leakage and thus affecting the color performance and the optical performance of the color display device.

### SUMMARY

At least one embodiment of the present disclosure provides a display device that can effectively filter the light from a front light module and reduce the light leakage caused by internal refraction or scattering when the light from the front light module enters the display panel, thereby improving the color performance and the optical performance of the display device.

The display device according to at least one embodiment of the present disclosure includes a first substrate, a display medium layer, a first color filter layer, a second substrate, a front light module, and a second color filter layer. The display medium layer is disposed on the first substrate. The first color filter layer is disposed on the display medium layer and includes multiple first color filter patterns. The second substrate is disposed on the first color filter layer. The front light module is disposed on the second substrate. The second color filter layer is disposed between the second substrate and the front light module, and includes multiple second color filter patterns.

The display device according to at least another embodiment of the present disclosure includes a first substrate, a display medium layer, a first color filter layer, a second substrate, a front light module, and a second color filter layer. The display medium layer is disposed on the first substrate. The first color filter layer is disposed on the display medium layer and includes multiple first color filter patterns. The second substrate is disposed on the first color filter layer. The front light module is disposed on the second substrate. The second color filter layer is disposed between the second substrate and the front light module, and includes multiple second color filter patterns. The second color filter patterns overlap the first color filter patterns in the normal line of the first substrate, respectively.

It is to be understood that both the foregoing general description and the following detailed description are by examples, and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1A is a schematic cross-sectional view of a display device according to at least one embodiment of the present disclosure.

FIG. 1B is a schematic cross-sectional view of a display device according to at least another embodiment of the present disclosure.

FIG. 1C is a schematic cross-sectional view of a display device according to at least another embodiment of the present disclosure.

FIG. 2 is a schematic cross-sectional view of a display device according to at least another embodiment of the present disclosure.

FIG. 3 is a schematic cross-sectional view of a display device according to at least another embodiment of the present disclosure.

FIG. 4A is a color gamut diagram of a comparative example and a display device according to at least one embodiment of the present disclosure when a front light module is turned off.

FIG. 4B is a color gamut diagram of a comparative example and a display device according to at least one embodiment of the present disclosure when a front light module is turned on.

### DETAILED DESCRIPTION

The embodiments of the present disclosure are discussed in detail below. It will be appreciated, however, that the embodiments provide many applicable concepts which may be implemented in a wide variety of specific contexts. The discussed and disclosed embodiments are for illustrative purposes only and are not intended to limit the scope of patent applications in this case.

In the following description, in order to clearly present the technical features of the present disclosure, the dimensions of elements in the drawings will be enlarged in unequal proportions. Therefore, the description and explanation of the following embodiments are not limited to the sizes and shapes presented by the elements in the drawings, but should cover the sizes, shapes, and deviations of the two due to actual manufacturing processes and/or tolerances. For example, the flat surface shown in the drawings may have rough and/or non-linear characteristics, and the acute angle shown in the drawings may be round. Therefore, the elements presented in the drawings in this case are mainly for illustration, and are not intended to accurately depict the actual shape of the elements, nor are they intended to limit the scope of patent applications in this case.

The spatial relative terms used in the present disclosure, such as “below,” “under,” “above,” “on,” and the like, are intended to facilitate the recitation of a relative relationship between one element or feature and another as depicted in the drawings. The true meaning of these spatial relative terms includes other orientations. For example, the relationship between one element and another may change from “below” and “under” to “above” and “on” when the drawing is turned 180 degrees up or down. In addition, spatially relative descriptions used in the present disclosure should be interpreted in the same manner.

It should be understood that while the present disclosure may use terms such as “first”, “second”, “third” to describe various elements or features, these elements or features should not be limited by these terms. These terms are primarily used to distinguish one element from another, or one feature from another. In addition, the term “or” as used in the present disclosure may include, as appropriate, any one or a combination of the listed items in association.

Moreover, the present disclosure may be implemented or applied in various other specific embodiments, and the details of the present disclosure may be combined, modified, and altered in various embodiments based on different viewpoints and applications, without departing from the idea of the present disclosure.

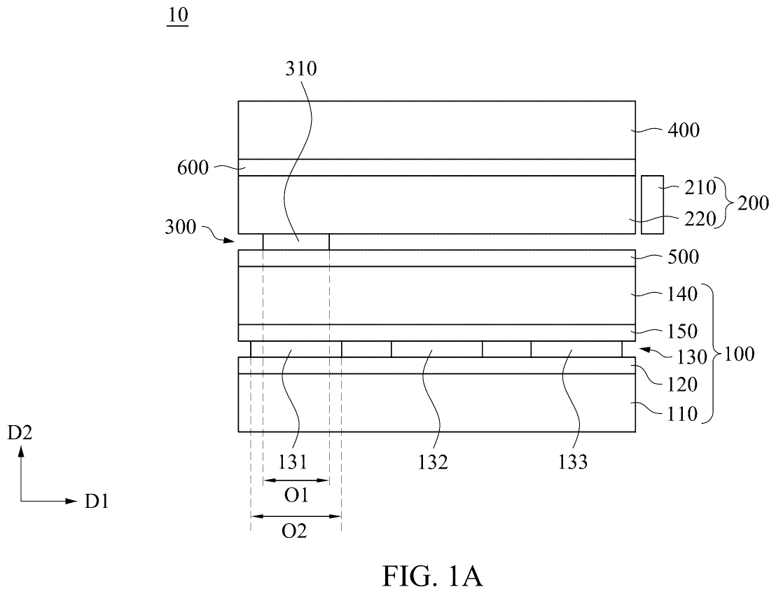

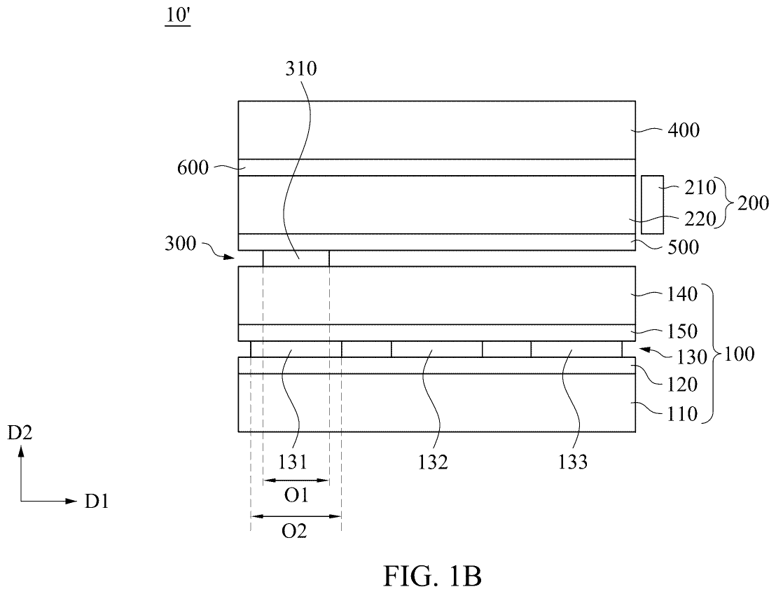

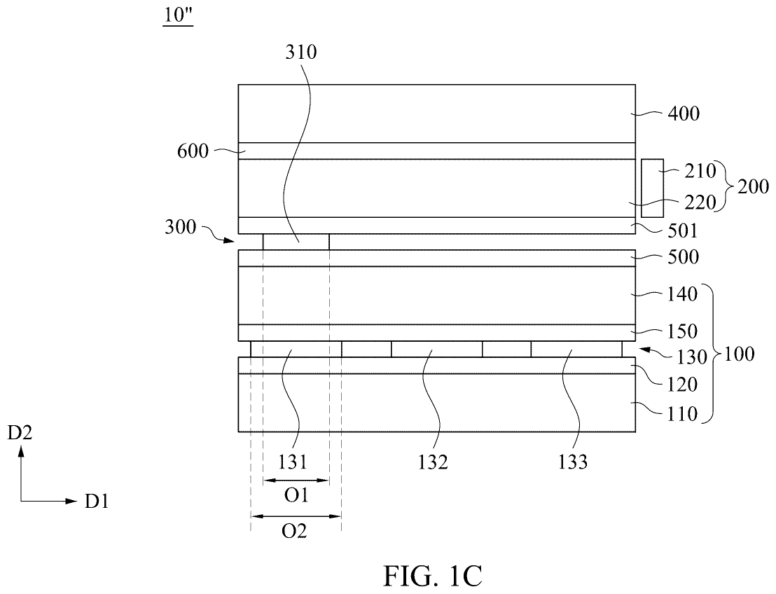

FIG. 1A is a schematic cross-sectional view of a display device 10 according to at least one embodiment of the present disclosure. The display device 10 includes a first substrate 110, a display medium layer 120, a first color filter layer 130, a second substrate 140, a front light module 200, and a second color filter layer 300.

The display medium layer 120 is disposed on the first substrate 110. The first color filter layer 130 is disposed on the display medium layer 120 and includes multiple first color filter patterns. The second substrate 140 is disposed on the first color filter layer 130. The front light module 200 is disposed on the second substrate 140. The second color filter layer 300 is disposed between the second substrate 140 and the front light module 200, and includes multiple second color filter patterns.

As shown in FIG. 1A, the display panel 100 includes the first substrate 110, the display medium layer 120, the first color filter layer 130, and the second substrate 140. By disposing the second color filter layer 300 between the display panel 100 and the front light module 200, the second color filter layer 300 can effectively filter the light from the front light module 200 and reduce the light leakage due to internal refraction or scattering when the light from the front light module 200 enters the display panel 100, thus improving the color performance and the optical performance of the display device 10.

Referring to FIG. 1A, the first color filter patterns include multiple first sub-patterns 131 with the same color, multiple second sub-patterns 132 with the same color, and multiple third sub-patterns 133 with the same color. The color of the first sub-patterns 131, the color of the second sub-patterns 132, and the color of the third sub-patterns 133 are different from each other. The second color filter patterns include multiple fourth sub-patterns 310 with the same color. In some embodiments, the first sub-pattern 131, the second sub-pattern 132, and the third sub-pattern 133 are sequentially arranged in a first direction D1.

In order to simplify the expression of the figure, FIG. 1A merely depicts one first sub-pattern 131, one second sub-pattern 132, one third sub-pattern 133, and one fourth sub-pattern 310 as representative representations. However, it can be understood that other first sub-patterns 131, other second sub-patterns 132, other third sub-patterns 133, and other fourth sub-patterns 310 may also be included where not shown on the page of the figure.

As shown in FIG. 1A, in the normal line of the first substrate 110, that is, in a second direction D2 perpendicular to the first direction D1, the fourth sub-patterns 310 overlap the first sub-patterns 131, respectively. The color of the fourth sub-pattern 310 is the same as the color of the first sub-patterns 131. In some embodiments, the color of the fourth sub-patterns 310 and the color of the first sub-patterns 131 are red, and the color of the second sub-patterns 132 and the color of the third sub-patterns 133 are green and blue, respectively.

However, the present disclosure is not limited thereto. In other embodiments, the color of the fourth sub-patterns 310 and the color of the first sub-patterns 131 may be green, and the color of the second sub-patterns 132 and the color of the third sub-patterns 133 may be red and blue, respectively. In other embodiments, the color of the fourth sub-patterns 310 and the color of the first sub-patterns 131 may be blue, and the color of the second sub-patterns 132 and the color of the third sub-patterns 133 may be red and green, respectively.

Referring to FIG. 1A, the orthographic projection ranges O1 of the fourth sub-patterns 310 on the first substrate 110 are located within the orthographic projection ranges O2 of the first sub-patterns 131 on the first substrate 110, respectively. That is, the orthographic projection areas of the fourth sub-patterns 310 on the first substrate 110 are smaller than the orthographic projection areas of the first sub-patterns 131 on the first substrate 110, respectively, and the orthogonal projection contours of the fourth sub-patterns 310 on the first substrate 110 are completely located within the orthographic projection contours of the first sub-patterns 131 on the first substrate 110, respectively.

Through the above-mentioned design, the color shift of the display device 10 due to the placement of the second color filter layer 300 farther away from the display medium layer 120 can be avoided, and thus the color performance of the display device 10 can be maintained.

In addition, the display device 10 further includes a first connecting layer 150, a second connecting layer 500, a third connecting layer 600, and a cover plate 400. The first connecting layer 150 is disposed between the first color filter layer 130 and the second substrate 140 for connecting the first color filter layer 130 to the second substrate 140, and the display panel 100 includes the first connecting layer 150.

The second connecting layer 500 is disposed between the second substrate 140 and the second color filter layer 300 for connecting the second substrate 140 to the second color filter layer 300. The cover plate 400 is disposed on the front light module 200, and the third connecting layer 600 is disposed between the front light module 200 and the cover plate 400 for connecting the front light module 200 to the cover plate 400.

As shown in FIG. 1A, the front light module 200 includes a light source 210 and a light guide plate 220, the light guide plate 220 having an upper surface facing the cover plate 400, and a lower surface opposite to the upper surface and facing the second color filter layer 300. The third connecting layer 600 is disposed between the upper surface of the light guide plate 220 and the cover plate 400 for connecting the light guide plate 220 to the cover plate 400.

In some embodiments, the distance between the second color filter layer 300 and the light guide plate 220 is less than the distance between the second color filter layer 300 and the first color filter layer 130. By the aforementioned design, avoiding excessive stacked layer structure between the front light module 200 and the second color filter layer 300, the light from the front light module 200 can be effectively filtered and the light leakage due to internal refraction or scattering when the light from the front light module 200 enters the second color filter layer 300 can be reduced, so the color performance and the optical performance of the display device 10 can be further improved.

In some embodiments, the first substrate 110 may be an array substrate, which may include, for example, pixel electrodes (not shown) and switching elements (not shown, such as transistors) or other electronic components (not shown, such as capacitors). The second substrate 140 may be, for example, a glass substrate, a plastic substrate, a silicon substrate, a flexible substrate, or other appropriate substrates. The light source 210 may be a light bar, and the light source 210 may be fixed to the side of the light guide plate 220 by using a fixing component (not shown), such as a tape or a housing.

The light guide plate 220 and the cover plate 400 may be a transparent substrate, such as a glass plate or a transparent plastic plate, and the material of the transparent plastic plate may be polyethylene terephthalate (PET), poly(methyl methacrylate) (PMMA), polycarbonate (PC), cyclic olefin copolymer (COC), cyclic olefin polymer (COP) and/or other suitable materials.

In some embodiments, the display medium layer 120 may be an electrophoretic display layer, but the present disclosure is not limited thereto. In other embodiments, the display medium layer 120 may be a liquid crystal display layer, an electrowetting display layer, an electronic liquid powder display layer, etc. The materials of the first connecting layer 150, the second connecting layer 500 and the third connecting layer 600 may be optical clear adhesive (OCA), optical clear resin (OCR) and/or other suitable materials.

In addition, the materials of the first color filter layer 130 and the second color filter layer 300 may be photoresist, such as red photoresist, green photoresist, blue photoresist, yellow photoresist, cyan photoresist, and magenta photoresist. In some embodiments, the first color filter layer 130 may be formed on the first connecting layer 150 and the second color filter layer 300 may be formed on the second connecting layer 500 through a printing process, but the present disclosure is not limited thereto.

FIG. 1B is a schematic cross-sectional view of a display device 10′ according to at least another embodiment of the present disclosure. Referring to FIG. 1B, the structures, the materials, the manufacturing processes and the relative positions of most elements in the embodiment of FIG. 1B and the embodiment of FIG. 1A are the same, so the same features are not repeated here. The difference between the embodiment of FIG. 1B and the embodiment of FIG. 1A is that the second connecting layer 500 of the display device 10′ is disposed between the second color filter layer 300 and the front light module 200 for connecting the second color filter layer 300 to the front light module 200.

As shown in FIG. 1B, the second connecting layer 500 is disposed between the lower surface of the light guide plate 220 and the second color filter layer 300 for connecting the light guide plate 220 to the second color filter layer 300.

FIG. 1C is a schematic cross-sectional view of a display device 10″ according to at least another embodiment of the present disclosure. Referring to FIG. 1C, the structures, the materials, the manufacturing processes and the relative positions of most elements in the embodiment of FIG. 1C and the embodiment of FIG. 1A are the same, so the same features are not repeated here. The difference between the embodiment of FIG. 1C and the embodiment of FIG. 1A is that the display device 10″ further includes another second connecting layer 501.

As shown in FIG. 1C, the second connecting layer 501 is disposed between the second color filter layer 300 and the front light module 200 for connecting the second color filter layer 300 to the front light module 200. In detail, the second connecting layer 501 is disposed between the lower surface of the light guide plate 220 and the second color filter layer 300 for connecting the second color filter layer 300 to the front light module 200.

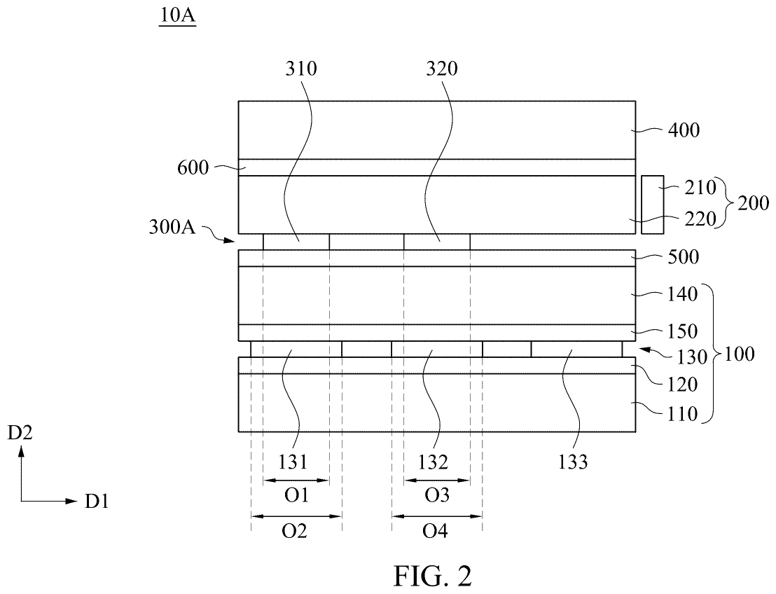

FIG. 2 is a schematic cross-sectional view of a display device 10A according to at least another embodiment of the present disclosure. Referring to FIG. 2, the structures, the materials, the manufacturing processes and the relative positions of most elements in the embodiment of FIG. 2 and the embodiment of FIG. 1A are the same, so the same features are not repeated here. The difference between the embodiment of FIG. 2 and the embodiment of FIG. 1A is that the second color filter patterns of the second color filter layer 300A of the display device 10A further include multiple fifth sub-patterns 320 with the same color.

In some embodiments, the fourth sub-pattern 310 and the fifth sub-pattern 320 are sequentially arranged in the first direction D1. In order to simplify the expression of the figure, FIG. 2 merely depicts one first sub-pattern 131, one second sub-pattern 132, one third sub-pattern 133, one fourth sub-pattern 310, and one fifth sub-pattern 320 as representative representations. However, it can be understood that other first sub-patterns 131, other second sub-patterns 132, other third sub-patterns 133, other fourth sub-patterns 310, and other fifth sub-patterns 320 may also be included where not shown on the page of the figure.

As shown in FIG. 2, in the normal line of the first substrate 110, the fifth sub-patterns 320 overlap the second sub-patterns 132, respectively. The color of the fifth sub-patterns 320 is the same as the color of the second sub-patterns 132, and the color of the fifth sub-patterns 320 is different from the color of the fourth sub-patterns 310. In some embodiments, the color of the fourth sub-patterns 310 and the color of the first sub-patterns 131 are red, the color of the fifth sub-patterns 320 and the color of the second sub-patterns 132 are green, and the color of the third sub-patterns 133 is blue.

However, the present disclosure is not limited thereto. In other embodiments, the color of the fourth sub-patterns 310 and the color of the first sub-patterns 131 may be red, the color of the fifth sub-patterns 320 and the color of the second sub-patterns 132 may be blue, and the color of the third sub-patterns 133 may be green. In other embodiments, the color of the fourth sub-patterns 310 and the color of the first sub-patterns 131 may be blue, the color of the fifth sub-patterns 320 and the color of the second sub-patterns 132 may be green, and the color of the third sub-patterns 133 may be red.

Referring to FIG. 2, the orthographic projection ranges O3 of the fifth sub-patterns 320 on the first substrate 110 are located within the orthographic projection ranges O4 of the second sub-patterns 132 on the first substrate 110, respectively. That is, the orthographic projection areas of the fifth sub-patterns 320 on the first substrate 110 are smaller than the orthographic projection areas of the second sub-patterns 132 on the first substrate 110, respectively, and the orthogonal projection contours of the fifth sub-patterns 320 on the first substrate 110 are completely located within the orthographic projection contours of the second sub-patterns 132 on the first substrate 110, respectively.

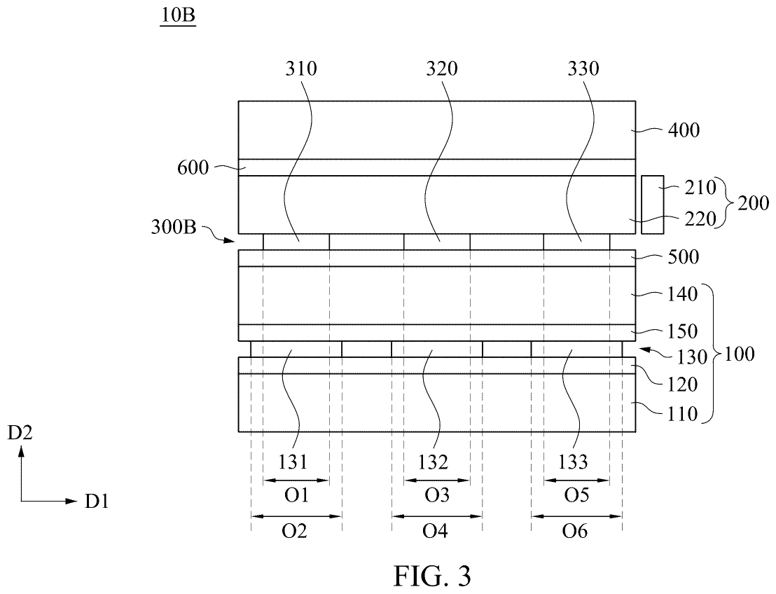

FIG. 3 is a schematic cross-sectional view of a display device 10B according to at least another embodiment of the present disclosure. Referring to FIG. 3, the structures, the materials, the manufacturing processes and the relative positions of most elements in the embodiment of FIG. 3 and the embodiment of FIG. 2 are the same, so the same features are not repeated here. The difference between the embodiment of FIG. 3 and the embodiment of FIG. 2 is that the second color filter patterns of the second color filter layer 300B of the display device 10B further include multiple sixth sub-patterns 330 with the same color.

In some embodiments, the fourth sub-pattern 310, the fifth sub-pattern 320, and the sixth sub-pattern 330 are sequentially arranged in the first direction D1. In order to simplify the expression of the figure, FIG. 3 merely depicts one first sub-pattern 131, one second sub-pattern 132, one third sub-pattern 133, one fourth sub-pattern 310, one fifth sub-pattern 320, and one sixth sub-pattern 330 as representative representations. However, it can be understood that other first sub-patterns 131, other second sub-patterns 132, other third sub-patterns 133, other fourth sub-patterns 310, other fifth sub-patterns 320, and other sixth sub-patterns 330 may also be included where not shown on the page of the figure.

As shown in FIG. 3, in the normal line of the first substrate 110, the sixth sub-patterns 330 overlap the third sub-patterns 133, respectively. The color of the sixth sub-patterns 330 is the same as the color of the third sub-patterns 133, and the color of the fourth sub-patterns 310, the color of the fifth sub-patterns 320, and the color of the sixth sub-patterns 330 are different from each other. In some embodiments, the color of the fourth sub-patterns 310 and the color of the first sub-patterns 131 are red, the color of the fifth sub-patterns 320 and the color of the second sub-patterns 132 are green, and the color of the sixth sub-patterns 330 and the color of the third sub-patterns 133 are blue.

Referring to FIG. 3, the orthographic projection ranges O5 of the sixth sub-patterns 330 on the first substrate 110 are located within the orthographic projection ranges O6 of the third sub-patterns 133 on the first substrate 110, respectively. That is, the orthographic projection areas of the sixth sub-patterns 330 on the first substrate 110 are smaller than the orthographic projection areas of the third sub-patterns 133 on the first substrate 110, respectively, and the orthogonal projection contours of the sixth sub-patterns 330 on the first substrate 110 are completely located within the orthographic projection contours of the third sub-patterns 133 on the first substrate 110, respectively.

In some embodiments, the number of the second color filter patterns is not greater than the number of the first color filter patterns. Taking the display device 10 of FIG. 1A and the display device 10A of FIG. 2 as examples, the number of the second color filter patterns of the second color filter layer 300 and the number of the second color filter patterns of the second color filter layer 300A are both less than the number of the first color filter patterns of the first color filter layer 130. Taking the display device 10B of FIG. 3 as an example, the number of second color filter patterns of the second color filter layer 300B is equal to the number of first color filter patterns of the first color filter layer 130.

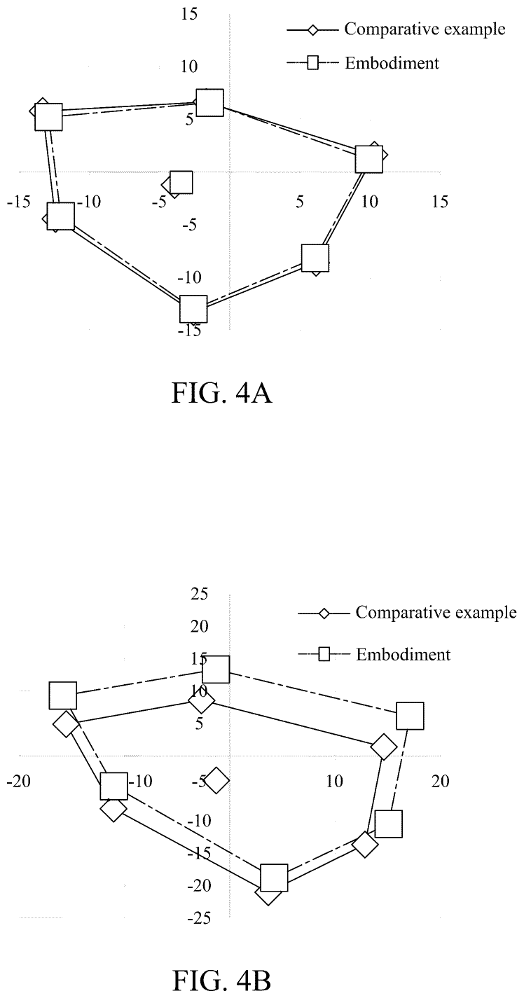

FIG. 4A is a color gamut diagram of a comparative example and a display device according to at least one embodiment of the present disclosure when a front light module is turned off. FIG. 4B is a color gamut diagram of a comparative example and a display device according to at least one embodiment of the present disclosure when a front light module is turned on. Referring to FIG. 4A and FIG. 4B. The horizontal axis is the a* value of the CIELAB color space, and the vertical axis is the b* value of the CIELAB color space.

The comparative example in FIG. 4A and FIG. 4B is that the display device 10 of FIG. 1A is not provided with the second color filter layer 300. The embodiment is the display device 10 of FIG. 1A, the color of the fourth sub-patterns 310 and the color of the first sub-patterns 131 are red, and the color of the second sub-pattern 132 and the color of the third sub-pattern 133 are green and blue, respectively.

The following table shows the measurement data of the comparative example and the embodiment when the front light module is turned off:

| The front light module is turned off | Contrast ratio | Color gamut |
|---|---|---|
| Comparative example | 14.45 | 3300 |
| Embodiment | 13.42 | 3134 |

As can be seen from the above table and FIG. 4A, when the front light module is turned off, there is not much difference in the color gamut of the comparative example and the color gamut of the embodiment. The color gamut and the contrast ratio of the comparative example are slightly greater than the color gamut and the contrast ratio of the embodiment.

The following table shows the measurement data of the comparative example and the embodiment when the front light module is turned on:

| The front light module is turned on | Contrast ratio | Color gamut |
|---|---|---|
| Comparative example | 12.46 | 13731 |
| Embodiment | 14.19 | 16154 |

As can be seen from the above table and FIG. 4B, when the front light module is turned on, the color gamut of the embodiment is significantly greater than the color gamut of the comparative example. The contrast ratio of the embodiment when the front light module is turned on is increased by 5.74% compared to the contrast ratio of the embodiment when the front light module is turned off, and the contrast ratio of the comparative example when the front light module is turned on is decreased by 13.77% compared to the contrast ratio of the comparative example when the front light module is turned off.

Therefore, when the front light module is turned on, compared with the comparative example, which is not provide with a second color filter layer, since the embodiment has the second color filter layer that can reduce the light leakage caused by internal refraction or scattering when the light from the front light module enters the display panel, the contrast ratio and the color gamut of the embodiment are greater than the contrast ratio and the color gamut of the comparative example, and thus the optical performance and the color performance of the display device can be effectively improved.

In summary, in at least one embodiment of the display device of the present disclosure, by disposing the second color filter layer between the front light module and the display panel including the first color filter layer, the second color filter layer can absorb the light leakage caused by internal refraction or scattering when the light from the front light module enters the display panel, and thus can improve the color performance and the optical performance of the display device.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. A display device, comprising:
a first substrate;
a display medium layer, disposed on the first substrate;
a first color filter layer, disposed on the display medium layer and comprising a plurality of first color filter patterns;
a second substrate, disposed on the first color filter layer;
a front light module, disposed on the second substrate; and
a second color filter layer, disposed between the second substrate and the front light module, and comprising a plurality of second color filter patterns.

2. The display device of claim 1, wherein a number of the second color filter patterns is not greater than a number of the first color filter patterns.

3. The display device of claim 2, wherein the first color filter patterns comprise a plurality of first sub-patterns with the same color, a plurality of second sub-patterns with the same color, and a plurality of third sub-patterns with the same color, wherein the color of the first sub-patterns, the color of the second sub-patterns, and the color of the third sub-patterns are different from each other, wherein the second color filter patterns comprise a plurality of fourth sub-patterns with the same color, and the fourth sub-patterns overlap the first sub-patterns in a normal line of the first substrate, respectively, wherein the color of the fourth sub-patterns is the same as the color of the first sub-patterns.

4. The display device of claim 3, wherein the color of the fourth sub-patterns and the color of the first sub-patterns are red.

5. The display device of claim 3, wherein orthographic projection ranges of the fourth sub-patterns on the first substrate are located within orthographic projection ranges of the first sub-patterns on the first substrate, respectively.

6. The display device of claim 5, wherein the second color filter patterns comprise a plurality of fifth sub-patterns with the same color, and the color of the fourth sub-patterns is different from the color of the fifth sub-patterns, wherein the fifth sub-patterns overlap the second sub-patterns in the normal line of the first substrate, respectively, wherein the color of the fifth sub-patterns is the same as the color of the second sub-patterns.

7. The display device of claim 6, wherein orthographic projection ranges of the fifth sub-patterns on the first substrate are located within orthographic projection ranges of the second sub-patterns on the first substrate, respectively.

8. The display device of claim 7, wherein the second color filter patterns comprise a plurality of sixth sub-patterns with the same color, and the color of the fourth sub-patterns, the color of the fifth sub-patterns, and the color of the sixth sub-patterns are different from each other, wherein the sixth sub-patterns overlap the third sub-patterns in the normal line of the first substrate, respectively, wherein the color of the sixth sub-patterns is the same as the color of the third sub-patterns.

9. The display device of claim 8, wherein orthographic projection ranges of the sixth sub-patterns on the first substrate are located within orthographic projection ranges of the third sub-patterns on the first substrate, respectively.

10. The display device of claim 1, wherein the front light module comprises a light source and a light guide plate, wherein a distance between the second color filter layer and the light guide plate is less than a distance between the second color filter layer and the first color filter layer.

11. The display device of claim 1, further comprising a connecting layer disposed between the second substrate and the second color filter layer, or disposed between the second color filter layer and the front light module.

12. The display device of claim 1, further comprising two connecting layers, wherein one of the two connecting layers is disposed between the second substrate and the second color filter layer, and the other of the two connecting layers is disposed between the second color filter layer and the front light module.

13. A display device, comprising:
a first substrate;
a display medium layer, disposed on the first substrate;
a first color filter layer, disposed on the display medium layer and comprising a plurality of first color filter patterns;
a second substrate, disposed on the first color filter layer;
a front light module, disposed on the second substrate; and
a second color filter layer, disposed between the second substrate and the front light module, and comprising a plurality of second color filter patterns, wherein the second color filter patterns overlap the first color filter patterns in a normal line of the first substrate, respectively.

14. The display device of claim 13, wherein orthographic projection ranges of the second color filter patterns on the first substrate are located within orthographic projection ranges of the first color filter patterns on the first substrate, respectively.

15. The display device of claim 13, wherein the front light module comprises a light source and a light guide plate, wherein a distance between the second color filter layer and the light guide plate is less than a distance between the second color filter layer and the first color filter layer.

16. The display device of claim 13, further comprising a connecting layer disposed between the second substrate and the second color filter layer, or disposed between the second color filter layer and the front light module.

17. The display device of claim 13, further comprising two connecting layers, wherein one of the two connecting layers is disposed between the second substrate and the second color filter layer, and the other of the two connecting layers is disposed between the second color filter layer and the front light module.
